(19) United States
(12) Patent Application Publication
(10) Pub. No.: US 2016/0134141 A1
(43) Pub. Date: May 12, 2016

(54) CHARGER FOR GROUP OF DEVICES

(71) Applicant: Microsoft Technology Licensing, LLC, Redmond, WA (US)

(72) Inventors: Lorenz Henric Jentz, Seattle, WA (US); Philip Bryan, Bellevue, WA (US); Monika Romana Wolf, Seattle, WA (US); Kenneth Dennis Jasinski, Seattle, WA (US); Ishmael Adams, Chicago, IL (US); Emron Henry, Seattle, WA (US); Dennis Matthew Puhalla, Oakland, CA (US); Richard James Wattles, Seattle, WA (US)

(21) Appl. No.: 14/536,564

(22) Filed: Nov. 7, 2014

(51) Int. Cl. H02J 7/00

(52) U.S. Cl. CPC H02J 7/0044

(57) ABSTRACT

A charger is described that is adapted to simultaneously charge a pair of portable devices, such as an audio input/output earpiece and a portable host device with which the audio input/output earpiece communicates wirelessly. In some cases, the charger includes spaces that are sized and shaped to receive the portable devices of the pair.

### CROSS-REFERENCE TO RELATED APPLICATION(S)

The present application is related to U.S. patent application Ser. No. 14/536,553, entitled “EARPIECE ATTACHMENT DEVICES,” filed Nov. 7, 2014, and U.S. patent application Ser. No. 14/536,557, entitled “SOUND TRANSMISSION SYSTEMS AND DEVICES HAVING EARPIECES,” filed Nov. 7, 2014, which are incorporated herein by reference in their entirety.

### TECHNICAL FIELD

The described technology is directed to the field of charging portable devices.

### BACKGROUND

Portable electronic devices generally consume electrical energy. In many cases, electrical energy consumed by a portable electronic device is obtained by an onboard storage system within the device, such as the storage system using chemical battery cells, a capacitor, or a supercapacitor. While some such onboard electrical energy storage systems are simply physically exchanged when their stored electrical energy is exhausted, in some cases these storage systems are rechargeable, such that they can receive and store additional electrical energy provided by external sources.

### BRIEF DESCRIPTION OF THE DRAWINGS

FIG. 1 is a network diagram showing interaction between various groups of devices that the charger can be used to charge in some embodiments.

FIG. 2 is a schematic diagram showing the charging relationship between the charger and various members of the device group.

FIG. 3A shows a side view of a first style of charger in an engaged state.

FIG. 3B shows a side view of the first style of charger, in a disengaged state.

FIG. 4A shows a top view of a second style of charger i in an engaged state.

FIG. 4B shows a top view of the second style of charger, in a disengaged state.

FIG. 5A shows a perspective view of a third style of charger in an engaged, open state.

FIG. 5B shows a perspective view of the third style of charger, in a disengaged, open state.

FIG. 5C shows a perspective view of the third style of charger, in a closed state.

FIG. 6A shows a top view of a fourth style of charger in a disengaged, open state.

FIG. 6B shows a top view of the fourth style of charger, in a closed state.

FIG. 7A shows a front isometric view of a fifth style of in a fully engaged, fully closed state.

FIG. 7C shows a front isometric view of the fifth style of charger, in a partly engaged, partly closed state.

FIG. 7B shows a front isometric view of the fifth style of charger, in a partly engaged, open state.

FIG. 8 shows a front isometric view of a sixth style of charger in a fully engaged, fully closed state.

FIG. 9 shows a front isometric view of a seventh style of charger in a fully engaged, fully closed state.

### DETAILED DESCRIPTION

Inventors have recognized that conventional charging systems for charging rechargeable electrical energy storage systems that are onboard in portable electronic devices are poorly suited to simultaneously charging multiple portable devices, such as two or more portable devices making up a cooperating group of portable devices. For example, many such conventional charging systems are designed for charging a single electronic device. To use these with multiple electronic devices, they must first be connected to charge a first one of the devices, then later connected to charge a second one of the devices, and any additional ones of the devices. Alternatively, multiple such charging systems must be provided in order to charge the multiple devices simultaneously, in many cases requiring the use and arrangement of multiple long cables, multiple electrical outlet plugs, and multiple electrical outlets. Further, the inventors have recognized that multiple devices simultaneously being charged by multiple conventional chargers can easily take over a work or storage surface or otherwise appear unruly or disorderly.

In order to more effectively and more elegantly charge multiple devices, the inventors have conceived and reduced to practice a charger for simultaneously charging a group of two or more devices, referred to hereinafter simply as “the charger.” In some embodiments, the charger is usable to charge devices such as an audio input/output earpiece (“the earpiece”) and a portable host device with which the audio input/output earpiece communicates wirelessly (“the host”). In some cases, separate structures intended for use together, such as the earpiece and the host, are referred to herein as multiple bodies of the same device.

In some embodiments, the charger takes the form of a single rigid housing encompassing two or more electrical connectors, or “charging features,” each designed to mate with corresponding connectors in a different one of the devices of the group. When the devices of the group are thus mated, they are held by the housing in particular locations and orientations relative to one another.

In some embodiments, the charger is in the form of a housing having openings or “voids” in its material sized and shaped to accept each of the devices of the group. In some such embodiments, a surface of the housing facing into each of the voids contains electrical contacts configured to interact with corresponding electrical contacts on each of the devices. In some such embodiments, the housing contains one or more wireless power transfer elements configured to wirelessly drive current generation by at least some of the devices. In some such embodiments, the housing contains wireless power transfer elements for generating current usable to charge the components based upon an externally imposed electromagnetic field. In some such embodiments, the charger can be manipulated in order to partially or fully enclose the devices, such as while being charged or while being transported to a new location.

Operating in some or all of the ways described above, the charger provides an effective, well-organized, and/or visually appealing way to charge, store, and/or transport devices of the group.

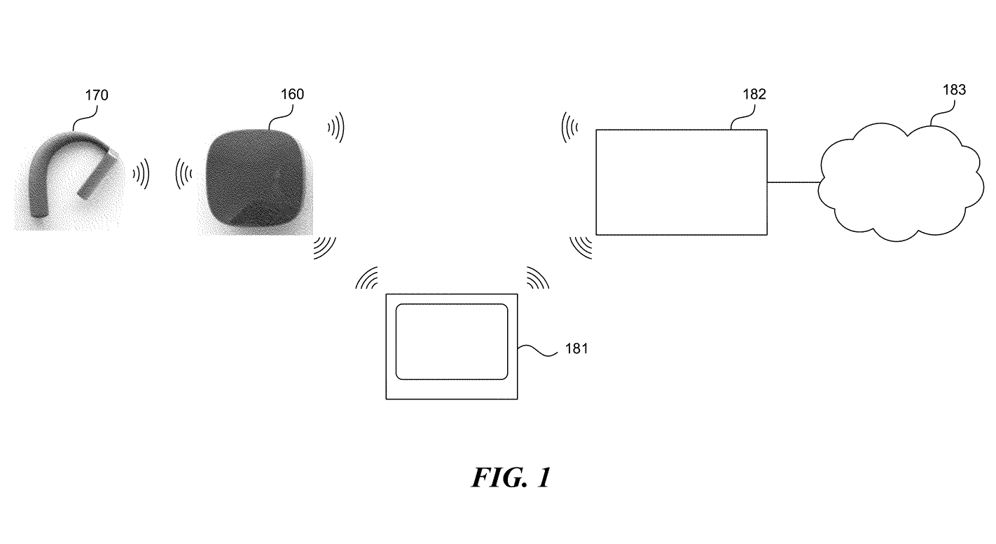

FIG. 1 is a network diagram showing interaction between various groups of devices that the charger can be used to charge in some embodiments. The devices include an earpiece 170 and a host 160. In various embodiments, the earpiece 170 rests on or attaches to a person's body on or near his or her ear; performs audio input and/or output with respect to the person; performs audio signal processing with respect to the inputted and/or outputted audio; and communicates wirelessly with the host 160. In various embodiments, the host 160 performs audio signal processing, including speech to text and/or text to speech transformations; data retrieval and processing; and wireless communication with the earpiece 170, with a wireless access point 182, and/or with an intermediary user device 181. The host 160 may be sized, for example, to fit easily in a pants pocket or a purse. In various embodiments, the intermediate user device 181 is of a variety of device types, such as a wireless phone or PDA, a tablet, or a laptop. In some embodiments, the intermediary user device 181 provides connectivity between the host and a wireless access point 182. The wireless access point 182 in turn provides connectivity to a network 183, such as the Internet or another network. In various embodiments, various wireless communication schemes and protocols are used between pairs of the shown components, including various variants of Bluetooth, IEEE 802.15.4, Wireless USB, UWB, 6loWPAN, ZigBee, Thread, Wi-Fi—802.11, RTT, EDGE, EV-DO, Flash-OFDM, GPRS, HSPA, LTE, UMTS, UMTS-TDD, and/or WiMAX—802.16.

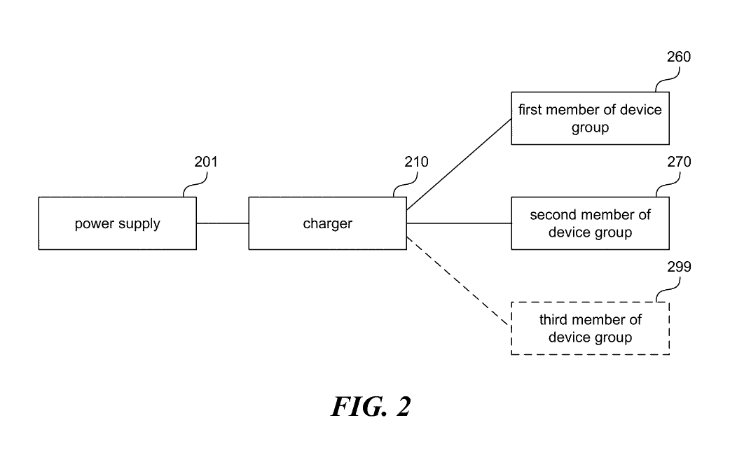

FIG. 2 is a schematic diagram showing the charging relationship between the charger and various members of the device group. The charger 210 is connected to a power supply 201 of any suitable type for providing electrical energy to a charger 210. In various embodiments, the power supply 201 provides a connection to an external source of power, such as via an electrical outlet, or itself performs the generation of electrical energy, such as by using a fuel cell, combustion generator, a solar generator, a hydroelectric generator, a wind-powered generator, an inductive generator for generating electrical energy from an electromagnetic field, etc. In some embodiments, the power supply 201 conditions or otherwise transforms the electrical energy it supplies to the charger. The charger 210 in turn simultaneously charges two or more devices making up a device group, such as device 260, device 270, and optionally device 299. The details of how the charger 210 connects to or otherwise interacts with the devices of the device group are described further below. As described above, each of the devices is charged to replenish the electrical energy stored in a storage system on board the device, which in various embodiments include storage subsystems of such types as chemical battery, capacitor, and supercapacitor.

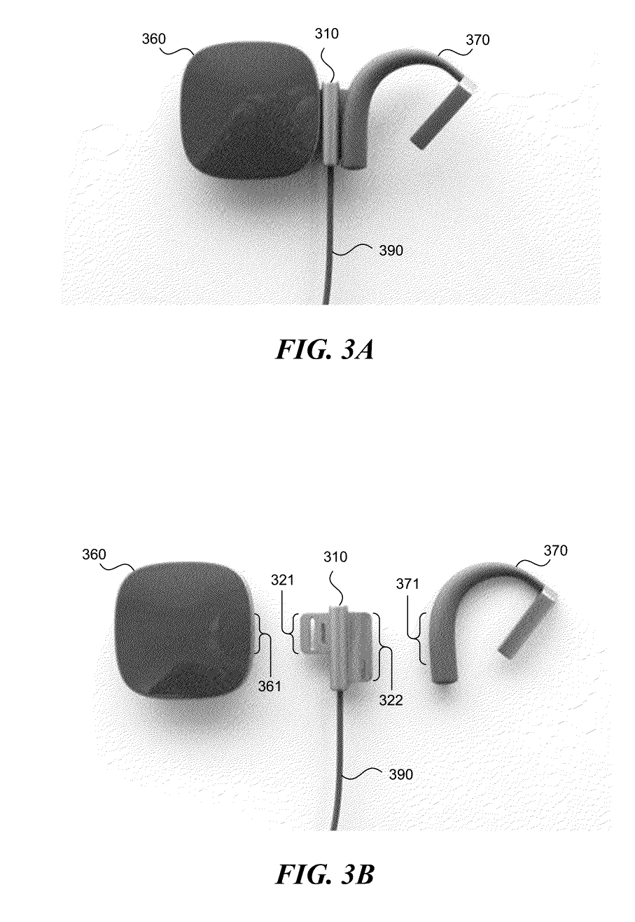

FIG. 3A shows a side view of a first style of charger in an engaged state. FIG. 3B shows a side view of the first style of charger, in a disengaged state. The shown charger of the first style includes a housing 310 that is connected by a cable 390 containing two or more electrical conductors to a power source (not shown). Two “charging features” 321 and 322 extend from the housing 310. The charging features 321 and 322 each contain multiple electrical contacts arranged to engage corresponding electrical contacts in connectors 361 and 371 of devices 360 and 370, respectively. The charging features 321 and 322 positively physically engage the connectors 361 and 371—such as magnetically or mechanically—such that a certain amount of force is necessary to separate a charging feature from a connector once engaged. In some embodiments, the charging features 321 and 322 slidably engage grooves within devices 360 and 370.

With the charging features 321 and 322 physically engaging the connectors 361 and 371, the electrical contacts of the charging features 321 and 322 are brought into contact with the corresponding electrical contacts in connectors 361 and 371, respectively, permitting current to flow between the charger and the devices 360 and 370, having the effect of charging the devices 360 and 370 by increasing the electrical energy stored by the storage systems onboard the devices 360 and 370. It can be seen that, in the engaged state shown in FIG. 3A, the charger and devices 360 and 370 are held together in a compact and uncluttered assembly. It can be seen that charging features 321 and 322 occur at the same point in the length of the housing 310, such that devices 360 and 370, when attached as shown in FIG. 3A, appear in a side-by-side arrangement. In other words, the charging features 321 and 322 each have a largest dimension; these largest dimensions of the charging features 321 and 322 are substantially parallel to each other, and substantially parallel to a largest dimension of the body 310. The charging features 321 and 322 are positioned so that there is at least one line that is substantially perpendicular to the largest dimensions of the charging features 321 and 322. While charging features 321 and 322 are shown to be of heterogeneous size in FIG. 3B, in various embodiments, the charging features 321 and 322 bear various relationships of size and shape to each other, including being more similar, or even identical. While only two charging features 321 and 322—for simultaneously charging two devices—are shown in FIGS. 3A-3B, in various embodiments, the charger has three or more charging features for simultaneously charging more than two devices.

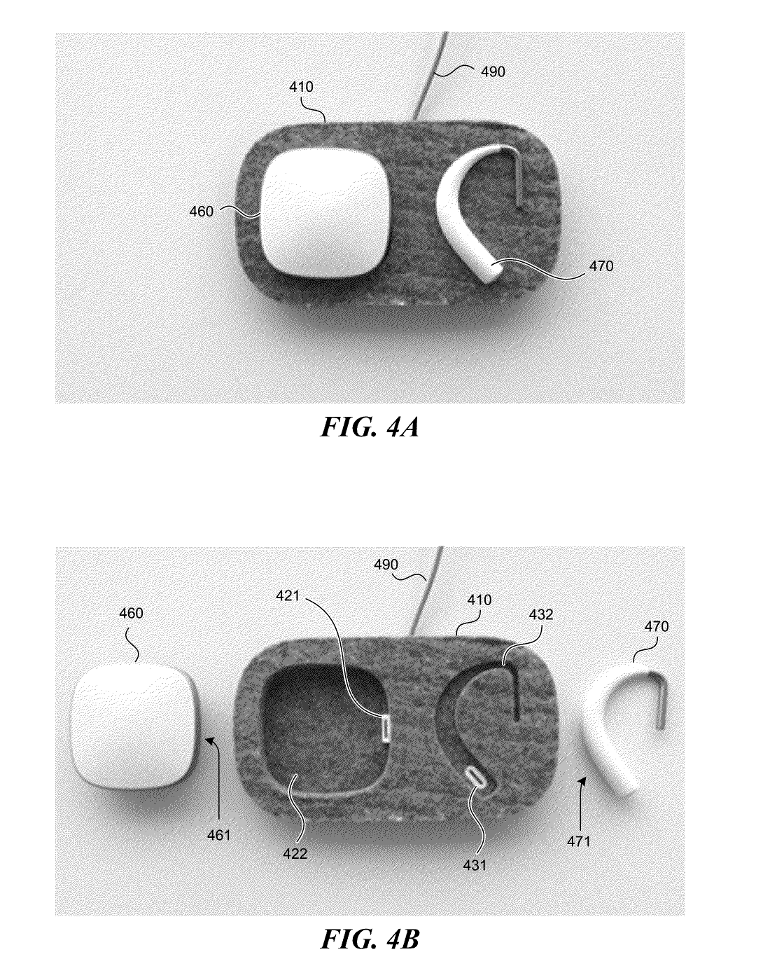

FIG. 4A shows a top view of a second style of charger in an engaged state. FIG. 4B shows a top view of the second style of charger, in a disengaged state. The shown charger of the second style includes a pad or other housing 410 either fully composed of or covered with a fabric or other soft material, such as felt or foam. As shown, power is provided to the housing 410 by a cable 490. In various embodiments, the cable 490 is connected to the housing 410 either permanently or via a detachable connector, such as a micro USB connector (not shown). In some embodiments of this and other styles not shown in FIGS. 4A-4B, rather than via a cable, electrical energy is supplied to the housing via wireless energy transfer, using additional electrical components contained in the housing 410 (not shown).

In various embodiments, for the different applications of wireless energy transfer discussed herein, various forms of wireless energy transfer are used, including forms of electromagnetic induction, such as electrodynamic induction and electrostatic induction; beamed power; microwave transmission; laser or other optical transmission; and magnetodynamic coupling. In some embodiments that use wireless energy transfer via electromagnetic induction, an induction coil is included in the charger, at least one charged device, or both.

The housing 410 has voids 422 and 432 sized and shaped so that the devices 460 and 470 fit inside the voids. In some embodiments, the devices 460 and 470 fit snugly inside the voids. In some embodiments, the devices 460 and 470 fit loosely inside the voids. As shown, a surface of each void 422 and 432 contains a charging feature 421 and 431, respectively. These charging features 421 and 431 electrically engage connectors 461 and 471 (out of view) in devices 460 and 470, respectively, as described above in connection with FIGS. 3A-3B. In some embodiments, these charging features 421 and 431 also physically engage connectors 461 and 471, respectively, as described above in connection with FIGS. 3A-3B. In some embodiments, the devices 460 and 470 are retained in the voids 422 and 432 by the snugness of the fit of the voids about the devices. In some embodiments, the devices 460 and 470 are retained in the voids 422 and 432 by a cover wrapped around the housing 410 (not shown). In some embodiments, rather than a charging feature with electrical contacts being contained by a surface of each void 422 and 432 as shown, at least one of the devices is charged via wireless energy transfer, using additional electrical components contained in the housing 410 (not shown).

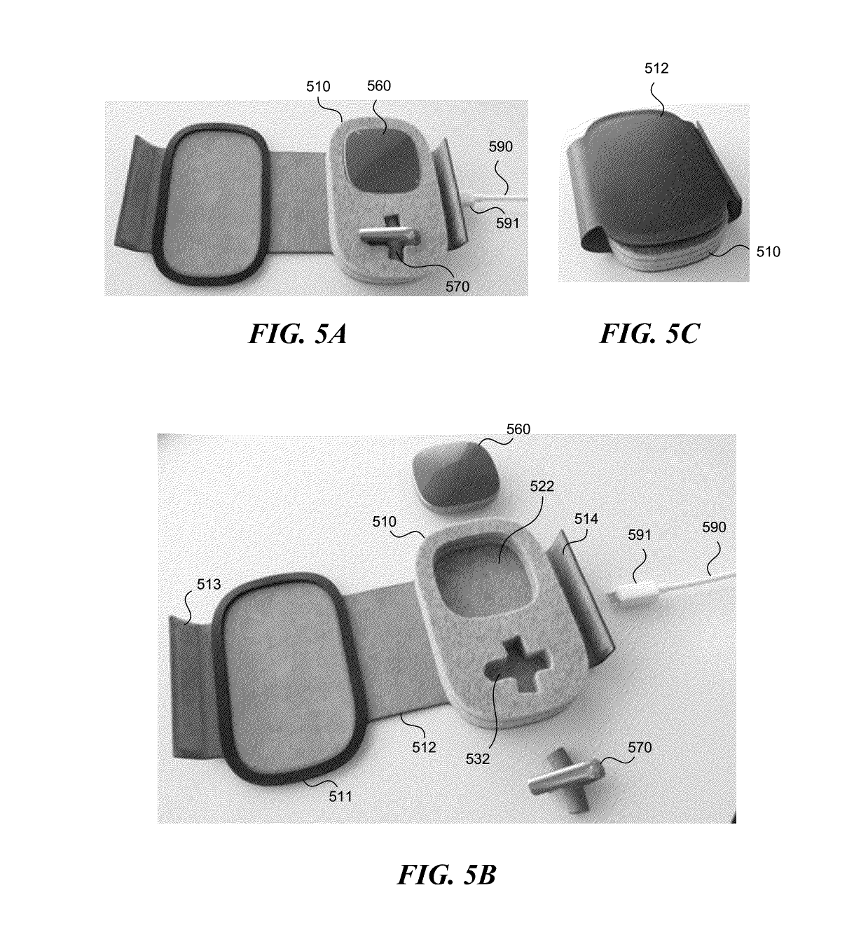

FIG. 5A shows a perspective view of a third style of charger in an engaged, open state. FIG. 5B shows a perspective view of the third style of charger, in a disengaged, open state. FIG. 5C shows a perspective view of the third style of charger, in a closed state. The third style of charger shown in FIGS. 5A-5C is similar to the second style of charger shown in FIGS. 4A-4B in several respects. Differences between the shown second and third styles of charger include that void 532 shown in FIG. 5B is shaped differently than void 432 shown in FIG. 4B to accommodate a difference in shape between device 570 shown in FIG. 5B and device 470 shown in FIG. 4B. Another difference is that the third style of charger shown in FIGS. 5A-5C includes a flexible cover 512. Integrated into the flexible cover 512 is a rigid piece 511. As shown in FIG. 5C, the flexible cover 512 wraps around the housing 510, positioning the rigid piece 511 over the top of the voids 522 and 532 to retain the devices 560 and 570. When closed, the flexible cover 512 can be secured with Velcro closures 513 and 514. In various embodiments not shown, the flexible cover 512 can be secured with closures of a variety of different types, such as a mechanical latch or a magnetic closure.

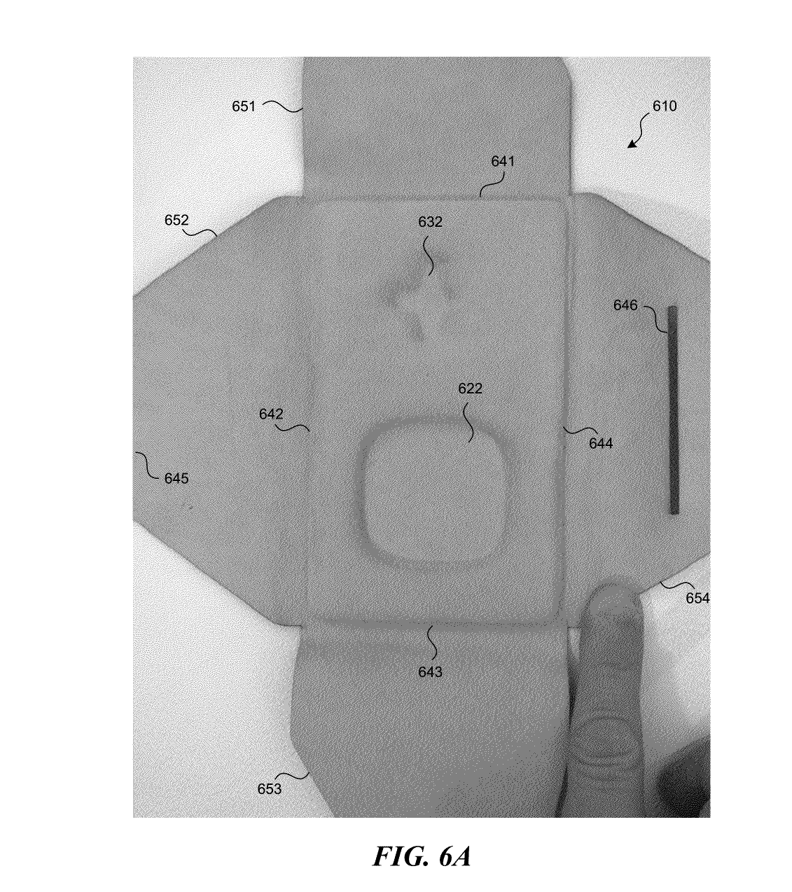

FIG. 6A shows a top view of a fourth style of charger in a disengaged, open state. FIG. 6B shows a top view of the fourth style of charger, in a closed state. The fourth style of charger 610 shown in FIGS. 6A-6B is similar to the third style of charger shown in FIGS. 5A-5C in several respects. Differences between the shown third and fourth styles of charger include that devices (not shown) are retained in voids 622 and 632 by a cover arranged from flaps 651, 652, 653, and 654, defined by folds 641, 642, 643, and 644, respectively. As can be seen in FIG. 6B, flaps 651 and 653 are first folded down; flap 654 is then folded down; finally, flap 652 is folded down, and tab 645 at the end of flap 652 is inserted in slot 646 in flap 654 to secure the cover.

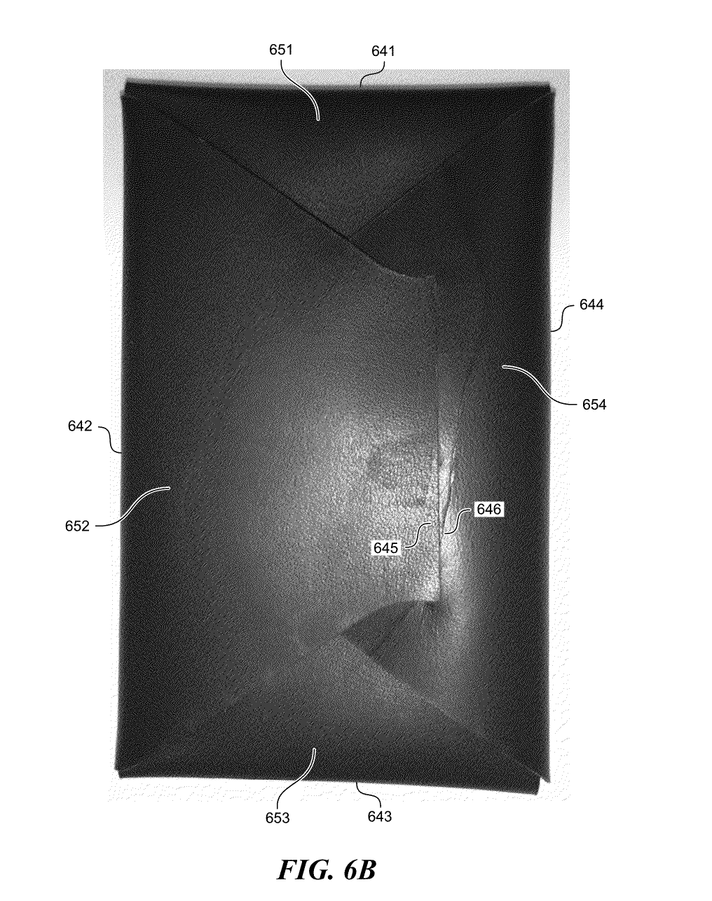

FIG. 7A shows a front isometric view of a fifth style of charger in a fully engaged, fully closed state. FIG. 7B shows a front isometric view of the fifth style of charger, in a partly engaged, partly closed state. FIG. 7C shows a front isometric view of the fifth style of charger, in a partly engaged, open state. In the fifth style of charger, the housing 710 is in the shape of a box that is open at the top. In various embodiments, the housing 710 receives electrical energy from a power supply in a variety of ways, such as via the shown cable 790. An earpiece device 770 rests in a void 732 at the bottom of the housing 710, and is electrically coupleable to conductors within the cable 790. A host device 760 rests in a void 731 corresponding to the top opening of the housing 710, such that it forms a lid for the housing 710. In the fifth style, the devices receive electrical energy in various ways described elsewhere herein in connection with the other styles.

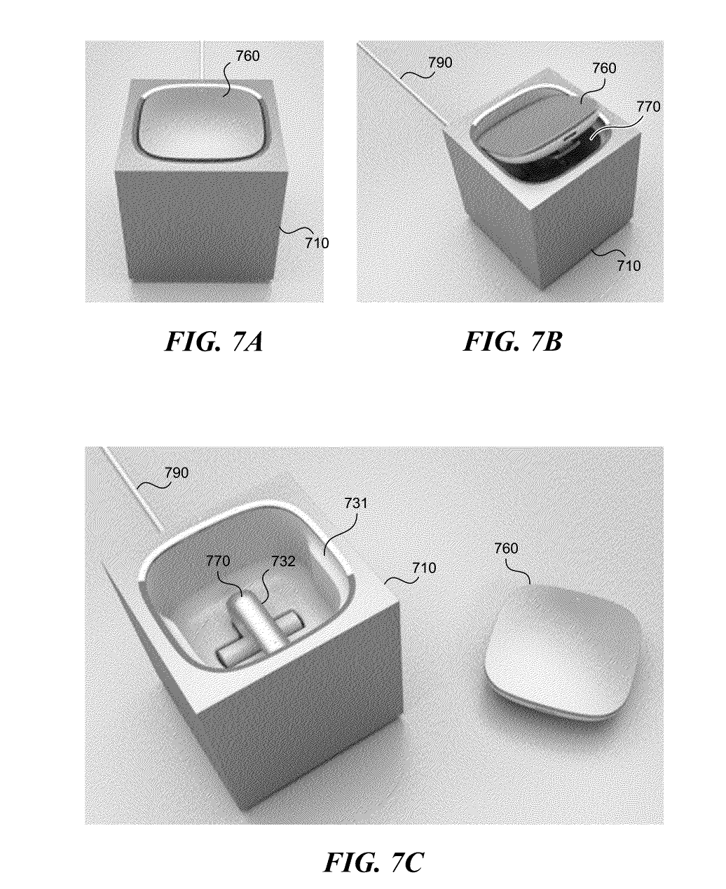

FIG. 8 shows a front isometric view of a sixth style of charger in a fully engaged, fully closed state. The sixth style of charger shown in FIG. 8 is similar to the fifth style of charger shown in FIGS. 7A-7C in several respects. Differences between the shown fifth and sixth styles of charger include that (1) the hosts 860 and 760 are of slightly different three-dimensional shapes; (2) the housings 810 and 710 are of slightly different three-dimensional shapes; and (3) the host 860 sits atop the housing 810, rather than sitting flush within the housing as host 760 does within housing 710.

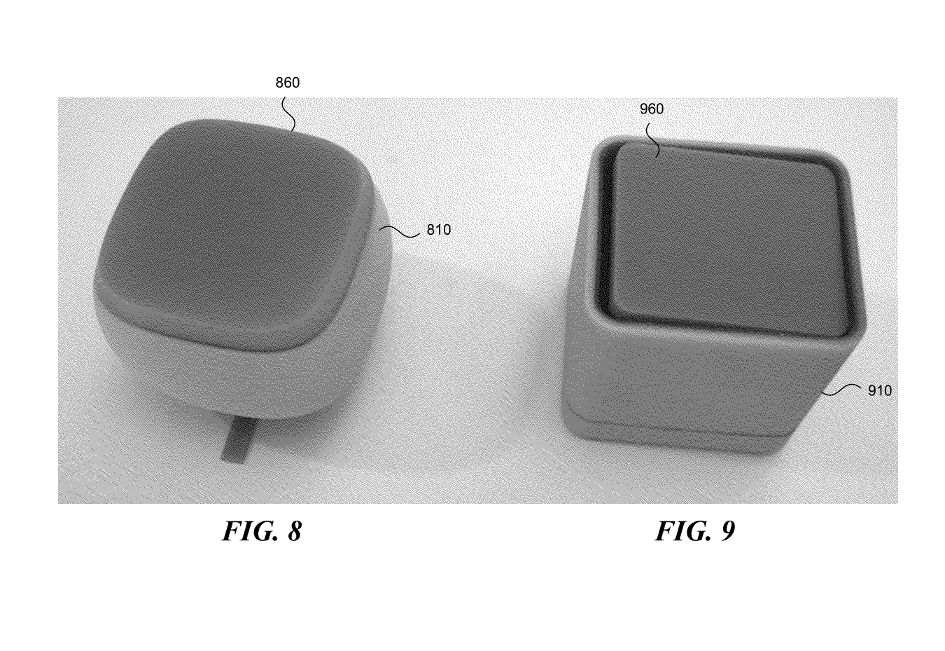

FIG. 9 shows a front isometric view of a seventh style of charger in a fully engaged, fully closed state. The seventh style of charger shown in FIG. 9 is similar to the fifth style of charger shown in FIGS. 7A-7C in several respects. Differences between the shown fifth and seventh styles of charger include that (1) the hosts 960 and 760 are of slightly different three-dimensional shapes; (2) the housings 910 and 710 are of slightly different three-dimensional shapes; and (3) the host 960 occupies more of the top of the housing 910 than does host 760 with respect to the top of housing 710.

In some embodiments, a charger for electrically charging portable device comprises a housing. The housing is configured to be coupled to a power source. The housing includes a first charging feature that extends from a first side of the housing and a second charging feature that extends from a second side of the housing. The first and second charging features each include multiple electrical contacts configured to electrically connect to corresponding electrical contacts of first and second bodies of the device.

In some embodiments, a charger electrically charges a pair of portable device that is configured to communicate wirelessly. The charger comprises a housing, that in turn includes a first charging feature and a second charging feature. The first and second charging features are sized and shaped to receive corresponding members of the pair of devices. The first and second charging features include a plurality of electrical contacts that are configured to conductively engage both members of the pair of portable devices.

In some embodiments, a charger for a pair of portable devices comprises an openable enclosure that (1) can be manipulated to substantially fully contain the pair of portable devices, and (2) can be manipulated to provide access adequate to remove the portable devices from the enclosure. The enclosure defines voids sized and shaped to receive the portable devices.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A charger for electrically charging a portable device, the charger comprising:
a housing configured to be coupled to a power source, wherein the housing includes a first charging feature extending from a first side of the housing and a second charging feature extending from a second side of the housing, wherein the first and second charging features each include a plurality of electrical contacts configured to electrically connect to corresponding electrical contacts of first and second bodies of the device.

2. The charger of claim 1 wherein the first body of the portable device is an audio input/output earpiece, and wherein the second body of the portable device is an audio signal processing unit that communicates wirelessly with the first body of the portable device.

3. The charger of claim 1 wherein the first and second sides of the housing are opposite sides of the housing, and wherein the first and second charging features extend in opposite directions.

4. The charger of claim 3 wherein the first and second charging features each have a largest dimension, and wherein the largest dimensions of the first and second charging features are substantially parallel, and wherein the first and second charging features are positioned so that there is at least one line that is substantially perpendicular to the largest dimensions of the first and second charging features.

5. The charger of claim 1 wherein the first and second charging features are configured to slidably engage corresponding grooves within the first and second bodies, respectively, of the device.

6. The charger of claim 1 wherein the first and second charging features are configured to magnetically attach to the first and second bodies, respectively, of the device.

7. A charger for electrically charging a pair of portable devices configured to communicate wirelessly, the charger comprising:
a housing, wherein the housing includes a first charging feature and a second charging feature, wherein the first and second charging features are sized and shaped to receive corresponding members of the pair of portable devices, and wherein the first and second charging features include a plurality of electrical contacts configured to conductively engage both members of the pair of portable devices.

8. The charger of claim 7 wherein the housing comprises a fabric pad, and wherein each of the first and second charging features comprises a void formed in the housing.

9. The charger of claim 7 wherein the first charging feature is formed in an opening of the housing such that a first member of the pair of portable devices forms a lid of the housing when the first charging feature receives the first member of the pair of portable devices.

10. The charger of claim 7 wherein the second charging feature is formed in an interior surface of an inner portion of the housing.

11. The charger of claim 7 wherein the housing comprises a generally rectangular solid shape.

12. The charger of claim 7 wherein the housing comprises a cube.

13. The charger of claim 7 wherein the housing is electrically coupleable to a plurality of electrical conductors.

14. The charger of claim 13 wherein at least one exterior surface of the housing is shaped to engage a cable incorporating a plurality of electrical conductors while the cable is wrapped around the housing.

15. The charger of claim 7 wherein the housing contains a wireless power transfer element for generating current.

16. The charger of claim 14 wherein the wireless power transfer element comprises an induction coil.

17. The charger of claim 7 wherein each of the first and second charging features include a plurality of electrical contacts configured to conductively engage each of the pair of portable devices.

18. The charger of claim 7 wherein the housing contains at least one wireless power transfer element configured to wirelessly drive current generation by at least one of the members of the pair of portable devices.

19. A charger for a pair of portable devices, the charger comprising:
an openable enclosure that (1) can be manipulated to substantially fully contain the pair of portable devices, and (2) can be manipulated to provide access adequate to remove the pair of portable devices from the enclosure, the enclosure defining voids sized and shaped to receive the pair of portable devices.

20. The charger of claim 19 wherein the enclosure includes a first plurality of electrical contacts positioned to engage electrical contracts of a first member of the pair of portable devices and a second plurality of electrical contacts positioned to engage electrical contacts of a second member of the pair of portable devices.
